(19) United States
(12) Patent Application Publication
(10) Pub. No.: US 2025/0046173 A1
(43) Pub. Date: Feb. 6, 2025

(54) Attachable Movement Notification Device

(71) Applicant: Eric Mitchell, Berkeley County, WV (US)

(72) Inventor: Eric Mitchell, Berkeley County, WV (US)

(21) Appl. No.: 18/485,402

(22) Filed: Oct. 12, 2023

Related U.S. Application Data
(60) Provisional application No. 63/517,472, filed on Aug. 3, 2023.

(51) Int. Cl. G08B 21/18

(52) U.S. Cl. CPC G08B 21/18

(57) ABSTRACT

An attachable movement-notification device is provided. The device is comprised of a body with at least one fastener that allows the device to be discretely attached to any portion of an object, item, etc. The device is comprised of at least one sensor that is preferably a motion sensor that detects motion of the device (and motion of the object the device is attached to). When motion is detected, a transmitter of the body communicates with a mobile application to alert a user that the object the device is attached to has been moved.

### CROSS-REFERENCE TO RELATED APPLICATION

The present application claims priority to, and the benefit of, U.S. Provisional Application No. 63/517,472, which was filed on Aug. 3, 2023, and is incorporated herein by reference in its entirety.

### FIELD OF THE INVENTION

The present invention relates generally to the field of motion-detecting devices. More specifically, the present invention relates to an attachable movement-notification device that can be indiscreetly or discretely attached to an object and wherein the device notifies a user via a mobile application when the object is moved. Accordingly, the present disclosure makes specific reference thereto. Nonetheless, it is to be appreciated that aspects of the present invention are also equally applicable to other like applications, devices, and methods of manufacture.

### BACKGROUND

Objects in our surroundings, whether in our homes or public spaces, often carry specific purposes, functions, or sentimental values. A significant number of these items are not designed or intended for indiscriminate or careless handling, especially by individuals who may not understand their risks, such as children. Such objects encompass a broad range including firearms, which can pose serious threats to safety; medications that could lead to unintentional overdoses or adverse reactions; electronic devices that can be damaged, misused, or could pose privacy risks, and so on.

While it might seem like a straightforward solution to simply lock these objects away to prevent unwanted access, doing so is not always feasible or desirable. There might be situations where immediate access is necessary or instances where locking them away could hinder their intended use. For example, in certain emergency scenarios, immediate access to items like medications or firearms might be crucial. Waiting to unlock or retrieve them could result in missed opportunities for timely interventions.

Furthermore, constantly locking and unlocking objects can become cumbersome and may interfere with their primary purposes. An electronic device meant for quick communications or work would lose its efficiency if one had to unlock a storage unit each time they needed to send an email or make a call. Similarly, medications might need to be readily accessible for individuals with chronic conditions requiring regular doses.

Additionally, from an aesthetic and convenience perspective, having to lock away everyday objects could disrupt the design and functionality of living spaces. It may not be desirable to have a living room or office cluttered with locked boxes or safes, especially when they might not blend seamlessly with the room's decor.

Therefore, there exists a long-felt need in the art for a device that notifies a user if an object is being moved or handled. There also exists a long-felt need in the art for an attachable movement-notification device. More specifically, there exists a long-felt need in the art for an attachable movement-notification device that can be attached to an object, wherein the device notifies a user if the object is moved. Further, there exists a long-felt need in the art for an attachable movement-notification device that can be attached to an object, wherein the device notifies a user if the object is moved and wherein the device can be indiscreetly or discretely attached to the object.

The subject matter disclosed and claimed herein, in one embodiment thereof, comprises an attachable movement-notification device. The device is comprised of a body with at least one fastener. The fastener allows the device to be discretely attached to any portion of an object, item, etc. The device is comprised of at least one sensor. The sensor is preferably a motion sensor that detects motion of the device (and motion of the object the device is attached to). When motion is detected, a transmitter of the body communicates with a mobile application to alert a user that the object the device is attached to has been moved.

In this manner, the attachable movement-notification device of the present invention accomplishes all the foregoing objectives and provides a device that notifies a user if an object is being moved or handled. To do so, the device can be attached to an object, wherein the device notifies a user if the object is moved. Further, the device can be discretely attached to the object via the fastener of the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an attachable movement-notification device. The device can be attached to any object via at least one fastener. Once attached to said object, at least one sensor of the device will detect any motion of the object and alert a user to said motion via a mobile application of the device.

The device is comprised of at least one fastener that may be positioned anywhere on the body of the device. The fastener is preferably a peelable adhesive fastener that allows the device to adhesively attach to any object. The body is also comprised of at least one sensor. The sensor is preferably a motion sensor that detects when the position of the sensor is moved. Once motion is detected by the sensor, at least one transmitter of the body transmits an alert from the sensor to at least one mobile application.

The mobile application has a plurality of functions. The mobile application alerts a user of any movement of the device (and object the device is attached to) via the sensor, using a mobile application notification, text, email, phone call, etc. The mobile application may also allow a user to set a threshold distance. More specifically, a user can set a threshold distance wherein the sensor is not active when the smart device the application is installed on is within a specific distance (i.e., 1 foot) of the device. This ensures the device and mobile application do not erroneously alert a user of movement if the user moves the object they have placed on the device on. However, when the smart device the mobile application is installed on is outside the threshold distance, the device and application will alert a user when movement of the device occurs. Alternatively, a user may use a disable feature of the application to disable the sensor when needed.

The present invention is also comprised of a method of using the device. First, a device is provided comprised of a body comprised of at least one fastener and at least one sensor, and at least one mobile application. Then, the device can be secured to an object via the fastener. Next, a user can download a mobile application to a smart device, such that the application alerts a user when the sensor detects motion of the device (and object).

The present invention is also comprised of a second method of using the device. First, a device is provided comprised of a body comprised of at least one fastener, at least one tracker, and at least one sensor, and a mobile application. Then, the device can be secured to an object via the fastener. Next, a user can download a mobile application to a smart device such that the application alerts a user when the sensor detects motion of the device (and object). In addition, a user can view the real-time location of the device via the mobile application.

Accordingly, the attachable movement-notification device of the present invention is particularly advantageous as it provides a device that notifies a user if an object is being moved or handled. To do so, the device can be attached to an object, wherein the device notifies a user if the object is moved. Further, the device can be discretely attached to the object via the fastener of the device. In this manner, the attachable movement-notification device provides a solution to ensuring objects or items are not mishandled without having to lock said objects or items away.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an attachable movement-notification device of the present invention in accordance with the disclosed architecture;

FIG. 2 illustrates a perspective view of one potential embodiment of an attachable movement-notification device of the present invention in accordance with the disclosed architecture;

FIG. 3 illustrates a perspective view of one potential embodiment of an attachable movement-notification device of the present invention while attached to an object in accordance with the disclosed architecture;

FIG. 4 illustrates a graphical view of a mobile application of one potential embodiment of an attachable movement-notification device of the present invention in accordance with the disclosed architecture;

FIG. 5 illustrates a flowchart of a method of using one potential embodiment of an attachable movement-notification device of the present invention in accordance with the disclosed architecture; and

FIG. 6 illustrates a flowchart of a method of using one potential embodiment of an attachable movement-notification device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that notifies a user if an object is being moved or handled. There also exists a long-felt need in the art for an attachable movement-notification device. More specifically, there exists a long-felt need in the art for an attachable movement-notification device that can be attached to an object, wherein the device notifies a user if the object is moved. Further, there exists a long-felt need in the art for an attachable movement-notification device that can be attached to an object, wherein the device notifies a user if the object is moved and wherein the device can be discretely attached to the object.

The present invention, in one exemplary embodiment, is comprised of an attachable movement-notification device that can be attached to any object via at least one fastener. Once attached to said object, at least one sensor of the device will detect any motion of the object and alert a user to said motion via a mobile application of the device.

The device is comprised of at least one fastener that may be positioned anywhere on the body of the device. The fastener is preferably a peelable adhesive fastener that allows the device to adhesively attach to any object. The body is also comprised of at least one sensor that is preferably a motion sensor that detects when the position of the sensor is moved. Once motion is detected by the sensor, at least one transmitter of the body transmits an alert from the sensor to at least one mobile application.

The mobile application has a plurality of functions, such as alerting a user when any movement of the device (and object the device is attached to) via the sensor, using a mobile application notification, text, email, phone call, etc. The mobile application may also allow a user to set a threshold distance. More specifically, a user can set a threshold distance wherein the sensor is not active when the smart device the application is installed on is within a specific distance (i.e., 1 foot) of the device. This ensures the device and mobile application do not erroneously alert a user of movement if the user moves the object they have placed on the device on. However, when the smart device the mobile application is installed on is outside the threshold distance, the device and application will alert a user when movement of the device occurs. Alternatively, a user may use a disable feature of the application to disable the sensor when needed.

The present invention is also comprised of a method of using the device. First, a device is provided comprised of a body comprised of at least one fastener and at least one sensor, and at least one mobile application. Then, the device can be secured to an object via the fastener. Next, a user can download a mobile application to a smart device, such that the application alerts a user when the sensor detects motion of the device (and object).

The present invention is also comprised of a second method of using the device. First, a device is provided comprised of a body comprised of at least one fastener, at least one tracker, at least one sensor, and a mobile application. Then, the device can be secured to an object via the fastener. Next, a user can download a mobile application to a smart device such that the application alerts a user when the sensor detects motion of the device (and object). In addition, a user can view the real-time location of the device via the mobile application.

Accordingly, the attachable movement-notification device of the present invention is particularly advantageous as it provides a device that notifies a user if an object is being moved or handled. To do so, the device can be attached to an object, wherein the device notifies a user if the object is moved. Further, the device can be discretely attached to the object via the fastener of the device. In this manner, the attachable movement-notification device provides a solution to ensuring objects or items are not mishandled without having to lock said objects or items away.

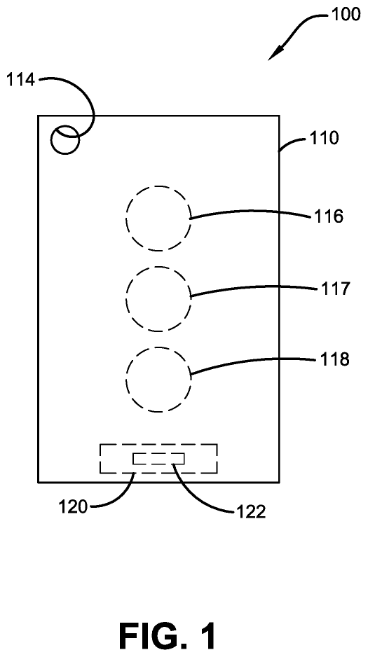

Referring initially to the drawings, FIG. 1 illustrates a perspective view of one potential embodiment of an attachable movement-notification device 100 of the present invention in accordance with the disclosed architecture. The device 100 can be attached to any object 10 via at least one fastener 112. Once attached to said object 10, at least one sensor 118 of the device 100 will detect any motion of the object 10 and alert a user to said motion via a mobile application 130 of the device 100.

The device 100 is comprised of a body 110. The body 110 may be any shape and size in different embodiments to allow the device 100 to attach to any object 10. The body 110 may be made of any material known in the art. In one embodiment, the body 110 is made from a material that matches the material of the object 10 the device 100 is secured to. In this manner, the device 100 blends in with the object 10.

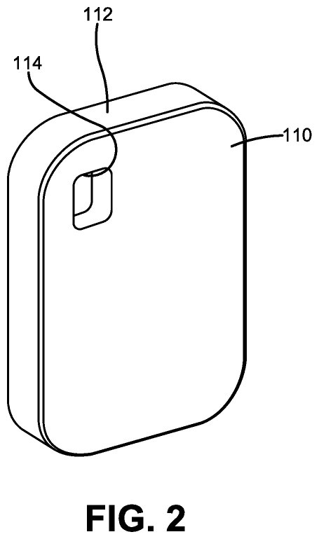

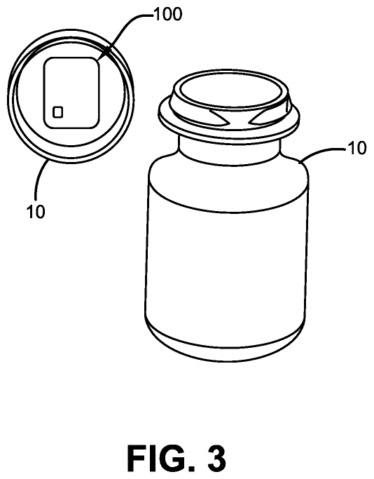

The device 100 is comprised of at least one fastener 112, as seen in FIG. 2. The fastener 112 may be positioned anywhere on the body 110. The fastener 112 is preferably a peelable adhesive fastener that allows the device 100 to adhesively attach to any object 10, as seen in FIG. 3. However, the fastener 112 may differ to secure to any specific object 10 type. In this manner, the fastener 112 may be fasteners such as, but not limited to, suction cup, hook and loop, magnet, snap button, etc. The body 110 may also be comprised of at least one opening 114. The opening 114 allows the body 110 to be attached to a keyring or otherwise tied to an object 10.

The body 110 is also comprised of at least one sensor 118. The sensor 118 is preferably a motion sensor 118 that detects when the position of the sensor 118 is moved. Said motion sensor 118 includes, but is not limited to, an accelerometer, a gyroscope, or a combo sensor (IMU).

Once motion is detected by the sensor 118, at least one transmitter 116 of the body 110 transmits an alert from the sensor 118 to at least one mobile application 130. The mobile application 130 may be in the form of an app for a smart device such as a tablet, cellphone, etc., or a computer software. The transmitter 116 is preferably a Bluetooth transmitter, but may be any type known in the art such as, but not limited to, Wi-Fi, NFC, etc.

The body 110 may also be comprised of a GPS tracker 117. The tracker 117 may be any type of GPS tracker known in the art. The tracker 117 provides the real-time location of the device 100 (and thus the object the device 100 is attached to) via the mobile application 130.

The sensor 118, transmitter 116, and tracker 117 may be powered by at least one battery 120. The battery 120 may be any type known in the art. The battery 120 may be disposable and replaceable in one embodiment. In another embodiment, the battery 120 is rechargeable via at least one charging port 122, such as, but limited to, any type of USB port.

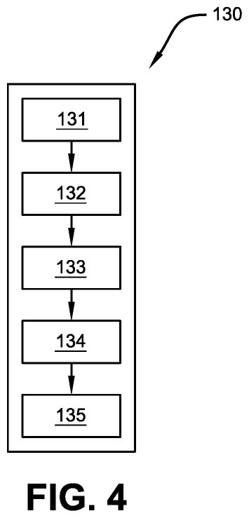

The mobile application 130 has a plurality of functions, as shown in FIG. 4. First, the mobile application 130 shows a user the real-time location 131 of the device 100 (and object 10 the device 100 is attached to) via a map interface of the mobile application. The mobile application 130 also alerts a user of any movement of the device 100 (and object 10 the device 100 is attached to) via the sensor 118, using a mobile application notification, text, email, phone call, etc. The mobile application 130 may also allow a user to set a threshold distance 133. More specifically, a user can set a threshold distance wherein the sensor 118 is not active when the smart device the application 130 is installed on is within a specific distance (i.e., 1 foot) of the device 100. This ensures the device 100 and mobile application 130 do not erroneously alert a user of movement if the user moves the object 10 they have placed on the device 100 on. However, when the smart device the mobile application 130 is installed on is outside the threshold distance, the device 100 and application 130 will alert a user when movement of the device 100 occurs. Alternatively, a user may use a disable 134 feature of the application 130 to disable the sensor 118 when needed. Further, the application 130 can be used to program the device 100 such that the sensor 118 is only active during a specific time period 135 (i.e., between 12 AM-5 AM).

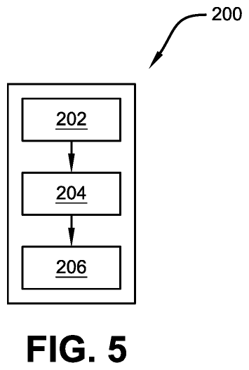

The present invention is also comprised of a method of using 200 the device 100, as seen in FIG. 5. First, a device 100 is provided comprised of a body 110 comprised of at least one fastener 112 and at least one sensor 118, and at least one mobile application 130 [Step 202]. Then, the device 100 can be secured to an object 10 via the fastener 112 [Step 204]. Next, a user can download a mobile application 130 to a smart device such that the application 130 alerts a user when the sensor 118 detects motion of the device 100 (and object 10) [Step 206].

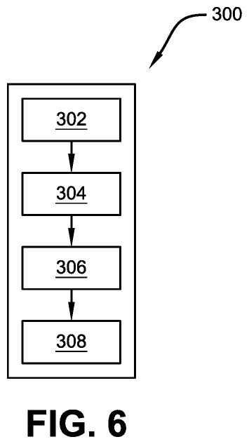

The present invention is also comprised of a second method of using 300 the device 100, as seen in FIG. 6. First, a device 100 is provided comprised of a body 110 comprised of at least one fastener 112, at least one tracker 117, and at least one sensor 118, and a mobile application 130 [Step 302]. Then, the device 100 can be secured to an object 10 via the fastener 112 [Step 304]. Next, a user can download a mobile application 130 to a smart device such that the application 130 alerts a user when the sensor 118 detects motion of the device 100 (and object 10) [Step 306]. In addition, a user can view the real-time location 131 of the device 100 via the mobile application 130 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “attachable movement-notification device” and “device” are interchangeable and refer to the attachable movement-notification device 100 of the present invention.

Notwithstanding the foregoing, the attachable movement-notification device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the attachable movement-notification device 100 as shown in the FIGS. are for illustrative purposes only, and that many other sizes and shapes of the attachable movement-notification device 100 are well within the scope of the present disclosure. Although the dimensions of the attachable movement-notification device 100 are important design parameters for user convenience, the attachable movement-notification device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attachable movement-notification device comprising:
a body comprised of a fastener;
a sensor;
a transmitter; and
a mobile application in wireless electrical communication with the transmitter.

2. The attachable movement-notification device of claim 1, wherein the fastener is comprised of a peelable adhesive fastener.

3. The attachable movement-notification device of claim 1, wherein the body is comprised of an opening.

4. The attachable movement-notification device of claim 1, wherein the sensor is comprised of a motion sensor.

5. The attachable movement-notification device of claim 1, wherein the transmitter is comprised of a Bluetooth transmitter.

6. An attachable movement-notification device comprising:
a body comprised of a fastener;
a sensor;
a battery;
a transmitter; and
a mobile application in wireless electrical communication with the transmitter.

7. The attachable movement-notification device of claim 6, wherein the sensor is comprised of a motion sensor.

8. The attachable movement-notification device of claim 7, wherein the motion sensor is comprised of an accelerometer, a gyroscope, or a combo sensor (IMU).

9. The attachable movement-notification device of claim 6, wherein the transmitter is comprised of a Wi-Fi transmitter.

10. The attachable movement-notification device of claim 6 further comprised of a GPS tracker.

11. The attachable movement-notification device of claim 6, wherein the fastener is comprised of a suction cup, a hook and loop fastener, a magnet, or a snap button fastener.

12. The attachable movement-notification device of claim 6, wherein the battery is comprised of a replaceable battery.

13. The attachable movement-notification device of claim 6, wherein the battery is comprised of a rechargeable battery.

14. The attachable movement-notification device of claim 13, wherein the rechargeable battery is comprised of a USB port.

15. The attachable movement-notification device of claim 6, wherein the mobile application displays the location of the GPS tracker via a map interface.

16. The attachable movement-notification device of claim 6, wherein the mobile application produces an alert when the motion sensor detects motion.

17. The attachable movement-notification device of claim 16, wherein the alert is comprised of a mobile application notification, a text, an email, or a phone call.

18. A method of using an attachable movement-notification device, the method comprising the following steps:
providing an attachable movement-notification device comprised of a body comprised of a fastener and a sensor, and a mobile application;
securing the device to an object via the fastener; and
downloading the mobile application on a smart device.

19. The method of using an attachable movement-notification device of claim 18, wherein the fastener is comprised of a peelable adhesive fastener.

20. The method of using an attachable movement-notification device of claim 18, wherein the mobile application alerts a user when the sensor detects motion.
